(19) United States
(12) Patent Application Publication
(10) Pub. No.: US 2023/0120424 A1
(43) Pub. Date: Apr. 20, 2023

(54) PROTECTION DEVICE, PROTECTION METHOD, AND UNMANNED AERIAL VEHICLE

(71) Applicant: Toyo Seikan Co., Ltd., Tokyo (JP)

(72) Inventors: Atsushi KOMINAMI, Kanagawa (JP); Souji ARAKI, Kanagawa (JP)

(21) Appl. No.: 17/915,473

(22) PCT Filed: Mar. 26, 2021
(86) PCT No.: PCT/JP2021/012950

§ 371 Date: Sep. 28, 2022

(30) Foreign Application Priority Data
Mar. 31, 2020 (JP) 2020-065014

(51) Int. Cl. B64U 20/83; B64U 20/87

(52) U.S. Cl. CPC B64U 20/83; B64U 20/87; B64U 2101/47

(57) ABSTRACT

Provided is a protection device for protecting a sensor mounted on an unmanned aerial vehicle. The protection device includes a housing and a nozzle provided in the housing and connected to a container, and protects the sensor by discharging a content of the container from the nozzle. The protection device may further include an information acquisition unit for acquiring information from an outside, and discharge the content from the nozzle based on the information acquired by the information acquisition unit. The protection device may further include an environment detection unit configured to detect a change in environment, and discharge the content from the nozzle based on the change detected by the environment detection unit. The protection device may further include a foreign object detection unit configured to detect a foreign object, and discharge the content from the nozzle in response to the foreign object detection unit detecting the foreign object.

### BACKGROUND

### 1. Technical Field

The present invention relates to a protection device, a protection method, and an unmanned aerial vehicle.

### 2. Related Art

Patent Documents 1 and 2 describe a device that generates an air flow in a housing so that dust or the like does not adhere to a sensor mounted on an unmanned aerial vehicle. In addition, Patent Document 3 describes a device that sprays a cleaning liquid to a sensor mounted on an unmanned aerial vehicle to clean a sensor surface.
Patent Document 1: International Publication No. 2018165937
Patent Document 2: International Publication No. 2019100316
Patent Document 3: Japanese translation publication of PCT route patent application No. 2019-526206

### TECHNICAL PROBLEM

With the expansion of the application range of the unmanned aerial vehicle, it is required to effectively protect the sensor in various environments.

### GENERAL DISCLOSURE

According to a first aspect of the present invention, there is provided a protection device for protecting a sensor mounted on an unmanned aerial vehicle. The protection device includes a housing and a nozzle provided in the housing and connected to a container. The sensor is protected by discharging a content of the container from the nozzle.

The protection device may further include an information acquisition unit configured to acquire information from an outside. The content may be discharged from the nozzle based on the information acquired by the information acquisition unit.

The information acquisition unit may acquire operation information from an operator.

The information acquisition unit may acquire information from the unmanned aerial vehicle.

The protection device may further include an environment detection unit configured to detect a change in environment. The content may be discharged from the nozzle based on the change detected by the environment detection unit.

The protection device may further include a foreign object detection unit configured to detect a foreign object, and may discharge the content from the nozzle in response to the foreign object detection unit detecting the foreign object.

The foreign object detection unit may be provided closer to an inlet of the housing than the sensor, and the nozzle may be provided between the sensor and the foreign object detection unit.

The foreign object detection unit may include a light receiving portion, and may detect a change in an amount of received light when the foreign object approaches the light receiving portion.

The foreign object detection unit may include an energization portion, and may detect a change in resistance when the foreign object comes into contact with the energization portion.

The nozzle may be provided between the sensor and the inlet of the housing, and the foreign object detection unit may operate as the sensor.

The housing may have a concave portion having a cylindrical or substantially tapered shape from an inlet of the housing toward a bottom portion, the sensor may be attached to the bottom portion, and the nozzle may be provided on a side surface of the concave portion.

The protection device may further include a container.

The content may be discharged from the nozzle in a direction different from the direction toward the sensor.

The discharged content may contain a liquid.

The discharged content may contain a repellent for a living body.

A second aspect of the present invention provides a protection method for protecting a sensor mounted on an unmanned aerial vehicle. The protection method includes protecting the sensor by discharging a content of a container from a nozzle connected to the container.

The protection method may further include acquiring information from an outside, and discharging the content from the nozzle based on the acquired information.

The protection method may further include detecting a change in environment and discharging the content from the nozzle based on the detected change.

The protection method may further include detecting an object and discharging the content from the nozzle in response to detecting the foreign object.

In a third aspect of the present invention, there is provided an unmanned aerial vehicle including a protection device according to the first aspect of the present invention.

The summary clause does not necessarily describe all necessary features of the embodiments of the present invention. The present invention may also be a sub-combination of the features described above.

### BRIEF DESCRIPTION OF THE DRAWINGS

FIG. 1 is a diagram illustrating an example of a configuration of an unmanned aerial vehicle 100.

FIG. 2 is a diagram illustrating an example of a configuration of a pilot device 200.

FIG. 3 is a diagram illustrating an example of a configuration of a terminal device 300.

FIG. 4A is a perspective view illustrating an example of a configuration of a housing 410.

FIG. 4B is a cross-sectional view of the housing 410 illustrated in FIG. 4A.

FIG. 5 is a diagram illustrating an example of a configuration of a discharge device 450.

FIG. 6 is a diagram illustrating an example of functional blocks of a protection device 400 according to Example 1.

FIG. 7A is a diagram illustrating an example of an operation state of the protection device 400.

FIG. 7B is a diagram illustrating an example of a cross section of the housing 410 in FIG. 7A.

FIG. 8 is a diagram illustrating an example of functional blocks of the protection device 400 according to Example 2.

FIG. 9A is a diagram illustrating an example of an operation state of the protection device 400.

FIG. 9B is a diagram illustrating an example of a cross section of the housing 410 in FIG. 9A.

FIG. 10 is a diagram illustrating an example of functional blocks of the protection device 400 according to Example 3.

FIG. 11A is a cross-sectional view of a housing 410 illustrating an example of a foreign object detection unit 412.

FIG. 11B is a diagram illustrating an example in which a foreign object 500 approaches the foreign object detection unit 412 illustrated in FIG. 11A.

FIG. 12A is a perspective view of the housing 410 illustrating another example of the foreign object detection unit 412.

FIG. 12B is a cross-sectional view of the housing 410 in FIG. 12A.

FIG. 13 is a cross-sectional view of the housing 410 illustrating another example of the foreign object detection unit 412.

FIG. 14 is a flowchart illustrating an example of a protection method.

FIG. 15 is a flowchart illustrating another example of the protection method.

FIG. 16 is a flowchart illustrating another example of the protection method.

### DESCRIPTION OF EXEMPLARY EMBODIMENTS

Hereinafter, the present invention will be described through embodiments of the invention, but the following embodiments do not limit the invention according to the claims. In addition, not all combinations of features described in the embodiments are essential to the solution of the invention.

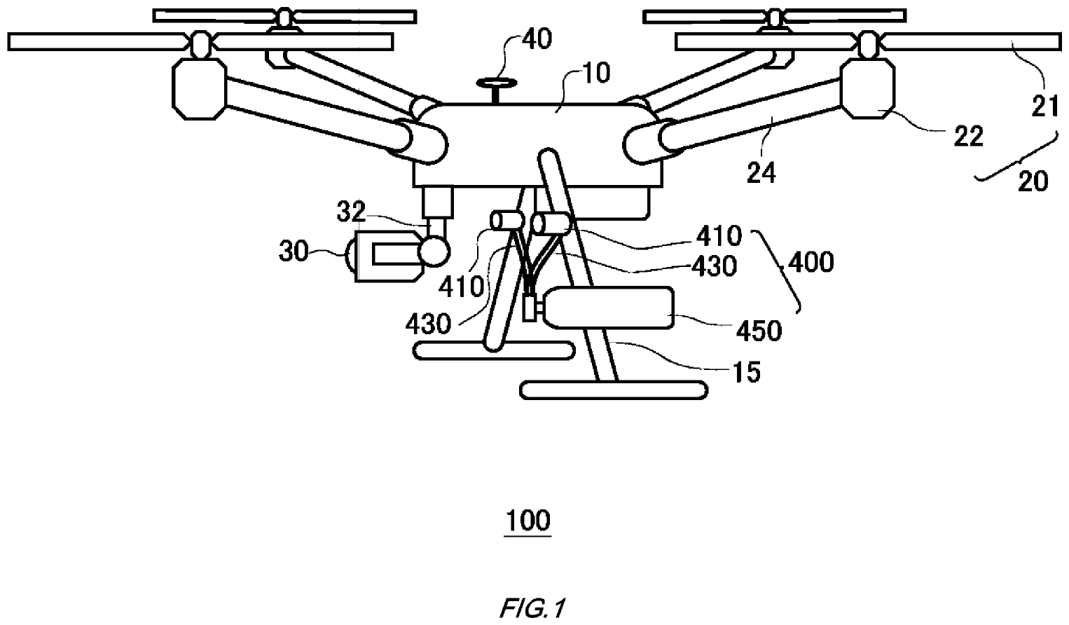

FIG. 1 is a diagram illustrating an example of the configuration of an unmanned aerial vehicle 100.

The unmanned aerial vehicle 100 is a flying body that flies in the air. The unmanned aerial vehicle 100 of the present example includes a main body 10, a propulsion unit 20, a movable camera 30, and a GPS information reception unit 40. Note that, in the present specification, a direction in which the movable camera 30 is directed in FIG. 1 is referred to as a front direction of the unmanned aerial vehicle 100, but the flight direction is not limited to the front direction.

The main body 10 stores various control circuits, a power supply, and the like of the unmanned aerial vehicle 100. In addition, the main body 10 may function as a structure body that couples the configurations of the unmanned aerial vehicle 100. The main body 10 in the present example is coupled to the propulsion unit 20.

The main body 10 is coupled to a leg portion 15. The leg portion 15 holds the posture of the unmanned aerial vehicle 100 at the time of landing. The leg portion 15 holds the posture of the unmanned aerial vehicle 100 in a state where the propulsion unit 20 is stopped. The unmanned aerial vehicle 100 of the present example has two leg portions 15. The movable camera 30 and the protection device 400 may be attached to the leg portion 15.

The propulsion unit 20 propels the unmanned aerial vehicle 100. The propulsion unit 20 includes rotation blades 21 and a rotation drive unit 22. The unmanned aerial vehicle 100 of the present example includes four propulsion units 20. The propulsion unit 20 is attached to the main body 10 via an arm portion 24. Note that the unmanned aerial vehicle 100 may be a flying body including fixed wings.

The propulsion unit 20 obtains a propulsive force by rotating the rotation blades 21. Four rotation blades 21 are provided around the main body 10, but the method of disposing the rotation blades 21 is not limited to the present example. The rotation blade 21 is provided at the edge of the arm portion 24 via the rotation drive unit 22.

The rotation drive unit 22 has a power source such as a motor and drives the rotation blade 21. The rotation drive unit 22 may have a brake mechanism of the rotation blade 21. The rotation blade 21 and the rotation drive unit 22 may be directly attached to the main body 10 without the arm portion 24.

The arm portion 24 is provided radially extending from the main body 10. The unmanned aerial vehicle 100 of the present example includes four arm portions 24 provided corresponding to the four propulsion units 20. The arm portion 24 may be fixed or movable. Another configuration such as a camera may be fixed to the arm portion 24.

The movable camera 30 captures an image around the unmanned aerial vehicle 100. The movable camera 30 of the present example is provided on the lower side of the main body 10. In one example, the lower side refers to the side opposite to the side on which the rotation blades 21 are provided with respect to the main body 10.

Although not illustrated in FIG. 1, the unmanned aerial vehicle 100 includes a fixed camera provided on a side surface of the main body 10 in addition to the movable camera 30. The movable camera 30 and the fixed camera capture videos of different regions. For example, the fixed camera acquires a video of the front of the unmanned aerial vehicle 100, and the movable camera 30 acquires a video of a region narrower than that of the fixed camera. In addition, when the fixed camera is capturing a video in the traveling direction, the movable camera 30 may capture a video in the discharge direction in which the protection device 400 described later discharges a content 465 of the container.

In one example, the videos captured by the movable camera 30 and the fixed camera are transmitted to the terminal device 300 described later. The pilot of the unmanned aerial vehicle 100 may pilot the unmanned aerial vehicle 100 based on the video captured by the fixed camera. In addition, the pilot of the unmanned aerial vehicle 100 may directly view and pilot the unmanned aerial vehicle 100.

The unmanned aerial vehicle 100 of the present example includes the fixed camera for piloting and the movable camera 30 for discharge control, whereby the operation by the operator is facilitated. Since it is not necessary to switch between the operation screen for piloting and the operation screen for discharge control, it is possible to prevent confusion of the pilot. In addition, it is possible to easily grasp the surroundings of the unmanned aerial vehicle 100 while performing the discharge control.

A coupling portion 32 couples the main body 10 and the movable camera 30. The coupling portion 32 may be fixed or movable. The coupling portion 32 may be a gimbal for controlling the position of the movable camera 30 in three axial directions.

The GPS information reception unit 40 is an antenna provided on a side surface of the main body 10. The GPS information reception unit 40 receives position information of the unmanned aerial vehicle 100 from a GPS satellite.

The protection device 400 that protects a sensor mounted on the unmanned aerial vehicle 100 is coupled to the unmanned aerial vehicle 100. The protection device 400 includes the housing 410, an extending portion 430, and the discharge device 450. The sensor may be a camera, an ultrasonic sensor, an optical sensor, or the like. The protection device 400 may be included as a component of the unmanned aerial vehicle 100.

The housing 410 is coupled to the main body 10. The housing 410 may be coupled to a member other than the main body 10 such as the arm portion 24 or the leg portion 15. In one example, the housing 410 has a concave portion 420 for accommodating a sensor.

The extending portion 430 is a tube for discharging the content 465 of a container 460. The extending portion 430 is provided to extend from the container 460 of the discharge device 450 to the housing 410, and couples the housing 410 and the discharge device 450. The extending portion 430 branches in the housing 410 and is connected to each nozzle 414 described later. The number of extending portions 430 may correspond to the number of the housings 410.

The discharge device 450 holds the container 460 to be described later filled with the content 465. The discharge device 450 is coupled to the main body 10. The discharge device 450 may be coupled to a member other than the main body 10 such as the arm portion 24 or the leg portion 15. In one example, the discharge device 450 is a cylindrical sleeve that accommodates the container 460.

The material of the discharge device 450 is not particularly limited as long as it can hold the shape of the accommodation portion for accommodating the container 460. For example, the material of the discharge device 450 includes a high strength and lightweight material such as metal such as aluminum, plastic, or carbon fiber. In addition, the material of the discharge device 450 is not limited to a hard material, and may include a soft material, for example, a rubber material such as silicone rubber or urethane foam. Note that the discharge device 450 may include a heating mechanism for heating or keeping the container 460 warm.

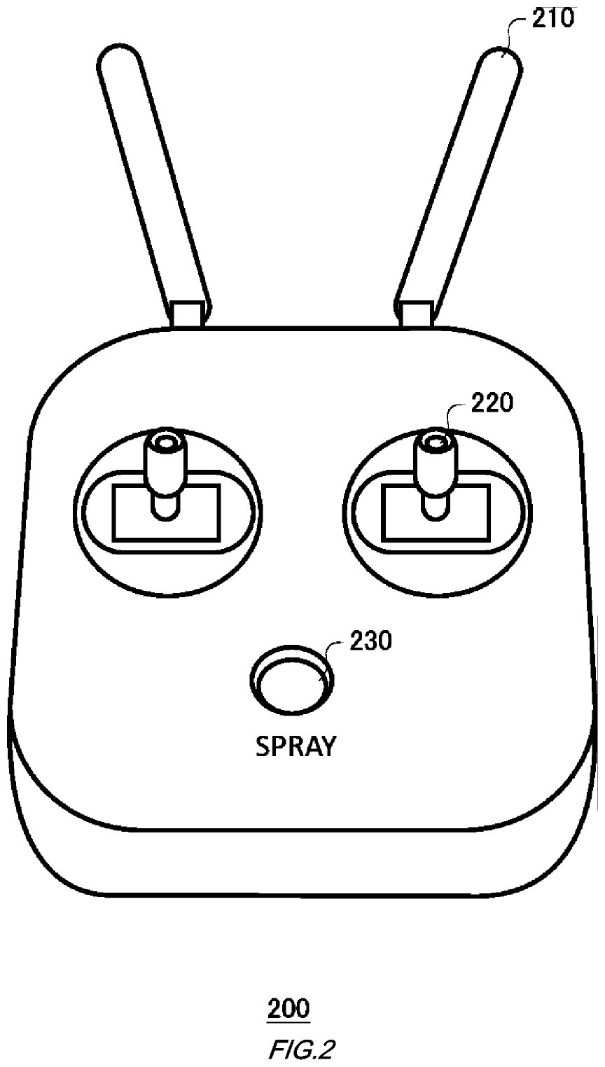

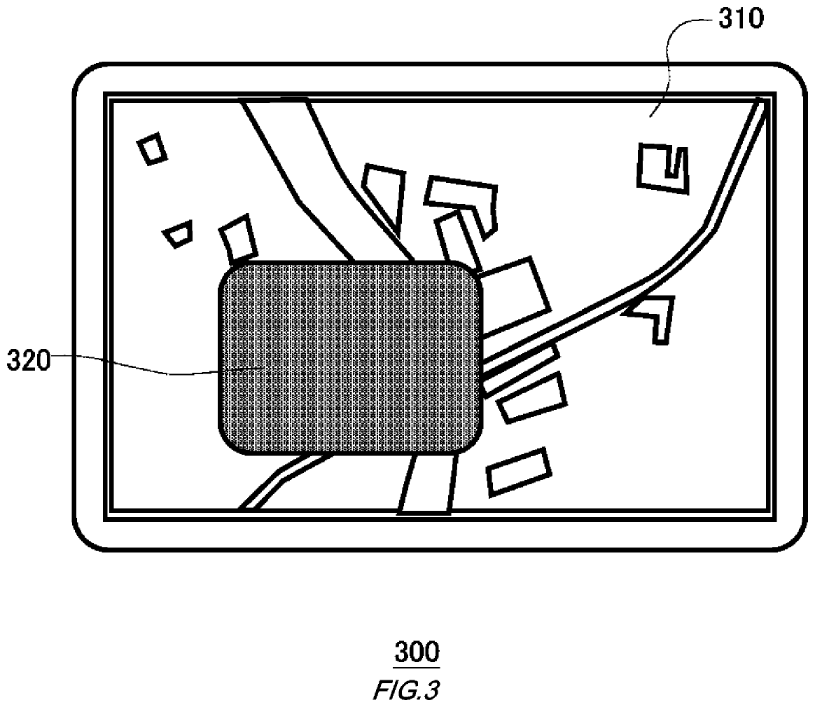

FIG. 2 is a diagram illustrating an example of the configuration of the pilot device 200. The pilot device 200 includes an antenna 210, a pilot stick 220, and a discharge button 230.

The pilot device 200 is communicably connected to the unmanned aerial vehicle 100 via the antenna 210. The pilot stick 220 is a device for a pilot of the unmanned aerial vehicle 100 to input a flight instruction of the unmanned aerial vehicle 100. The pilot device 200 transmits the flight instruction input by the pilot of the unmanned aerial vehicle 100 by operating the pilot stick 220 to the unmanned aerial vehicle 100, and controls the flight of the unmanned aerial vehicle 100.

The discharge button 230 is a device for the pilot of the unmanned aerial vehicle 100 to input a discharge instruction for discharging the content 465 of the container 460. The pilot device 200 transmits the discharge instruction input by the pilot of the unmanned aerial vehicle 100 by pressing the discharge button 230 to the protection device 400, and controls the discharge of the content 465 of the container 460.

The discharge button 230 may have a form other than a button such as a stick. The discharge button 230 may be integral with the pilot stick 220.

The pilot device 200 may be connected to the terminal device 300 in a wired or wireless manner. A plurality of pilot devices 200 may be provided and used for piloting the unmanned aerial vehicle 100 and for controlling the discharge of the protection device 400.

Note that the pilot in the present example manually pilots the unmanned aerial vehicle 100 using the pilot device 200. However, the pilot may pilot the unmanned aerial vehicle 100 automatically by a program instead of manually. In addition, the piloting of the unmanned aerial vehicle 100 may be automatically controlled, and the discharge of the protection device 400 may be manually operated.

FIG. 3 is a diagram illustrating an example of the configuration of the terminal device 300. The terminal device 300 includes a display unit 310. In one example, the terminal device 300 is a mobile terminal such as a smartphone and a tablet.

In one example, the display unit 310 displays map information of an area where the unmanned aerial vehicle 100 flies. The display unit 310 may display the position information of the unmanned aerial vehicle 100 acquired from the GPS information reception unit 40 while displaying the position information to be superimposed on the map information. In addition, as will be described later, the display unit 310 may indicate a preset operation area 320 of the protection device 400 on the map information.

Alternatively, the display unit 310 may display an image captured by each of the fixed camera and the movable camera 30 mounted on the unmanned aerial vehicle 100. For example, the display unit 310 displays images of the fixed camera and the movable camera 30 on divided screens. The terminal device 300 may directly communicate with the unmanned aerial vehicle 100, or may indirectly communicate with the unmanned aerial vehicle 100 via the pilot device 200. The terminal device 300 may be connected to an external server.

The terminal device 300 may further include an input device for the pilot to input discharge control information for controlling the discharge of the content 465. In one example, the discharge control information is information such as a discharge time, an interval, and the number of times.

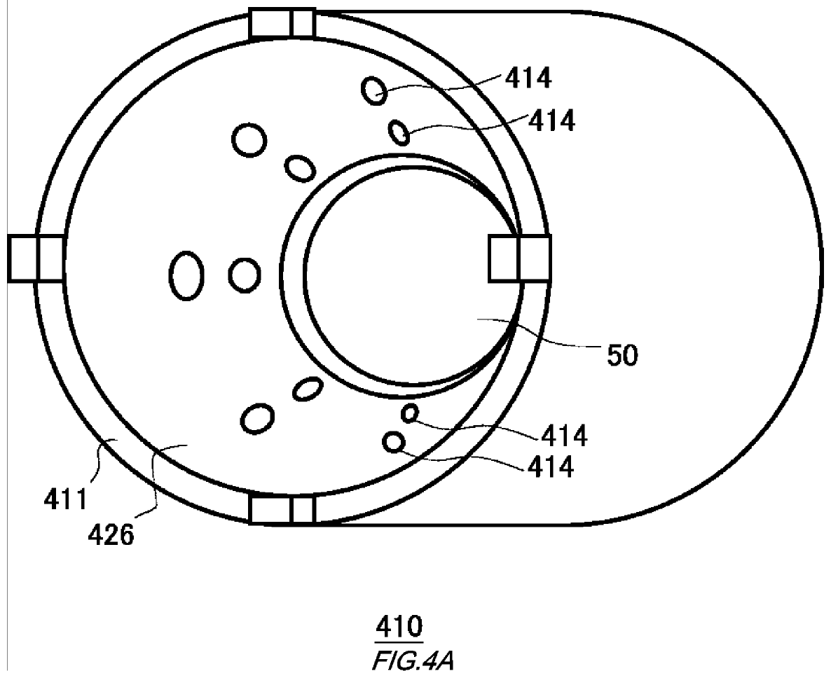

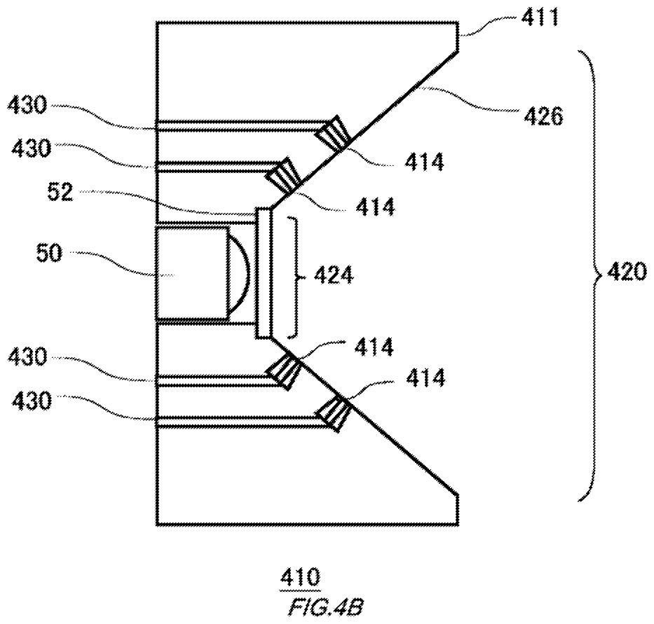

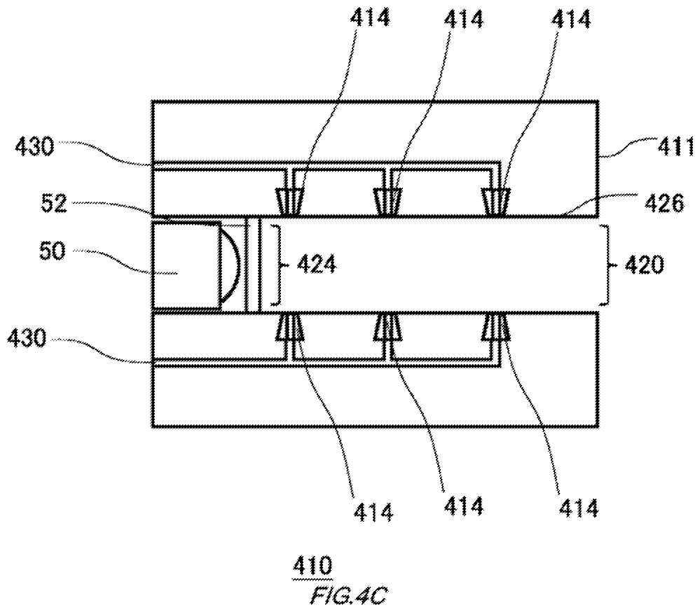

FIG. 4A is a perspective view illustrating an example of the configuration of the housing 410. The housing 410 has the concave portion 420 in which the sensor 50 is attached at the bottom portion 424. The sensor 50 may be a camera or a distance measuring sensor such as an ultrasonic sensor. The housing 410 may be provided with a temperature sensor 443 or a humidity sensor 444 (not illustrated).

The nozzle 414 is provided between an inlet 411 of the housing 410 and a sensor 50 attached to the bottom portion 424 of the concave portion 420. Although the number of nozzles 414 is not limited, in one example, a plurality of nozzles 414 are regularly disposed radially from the sensor 50 attached to the bottom portion 424.

FIG. 4B is a cross-sectional view of the housing 410 illustrated in FIG. 4A. The concave portion 420 illustrated in (a) of FIG. 4B has a substantially tapered shape from the inlet 411 toward the bottom portion 424 of housing 410. The concave portion 420 illustrated in (b) of FIG. 4B has a cylindrical shape with a constant inner diameter from the inlet 411 to the bottom portion 424 of the housing 410. The shape of the concave portion 420 is not limited to these, and may be any shape as long as it does not block the path between the sensor 50 attached to the bottom portion 424 and the external detection object.

The nozzle 414 is provided on the side surface 426 of the concave portion 420. Each nozzle 414 is connected to the extending portion 430 coupled to the housing 410, and discharges the content 465 of the container 460 from each nozzle 414.

In FIG. 4B, the orientation of each nozzle 414 is perpendicular to the side surface 426, but is not limited thereto. Each nozzle 414 may be disposed toward a direction different from the direction from the nozzle 414 to the sensor 50. That is, each nozzle 414 discharges the content 465 in a direction different from the direction toward the sensor 50.

In this way, since the content 465 discharged from the nozzle 414 by the protection device 400 does not directly hit the sensor 50, it is possible to avoid a detection error of the sensor 50 due to adhesion to the surface of the sensor 50, damage to the surface of the sensor 50, or the like.

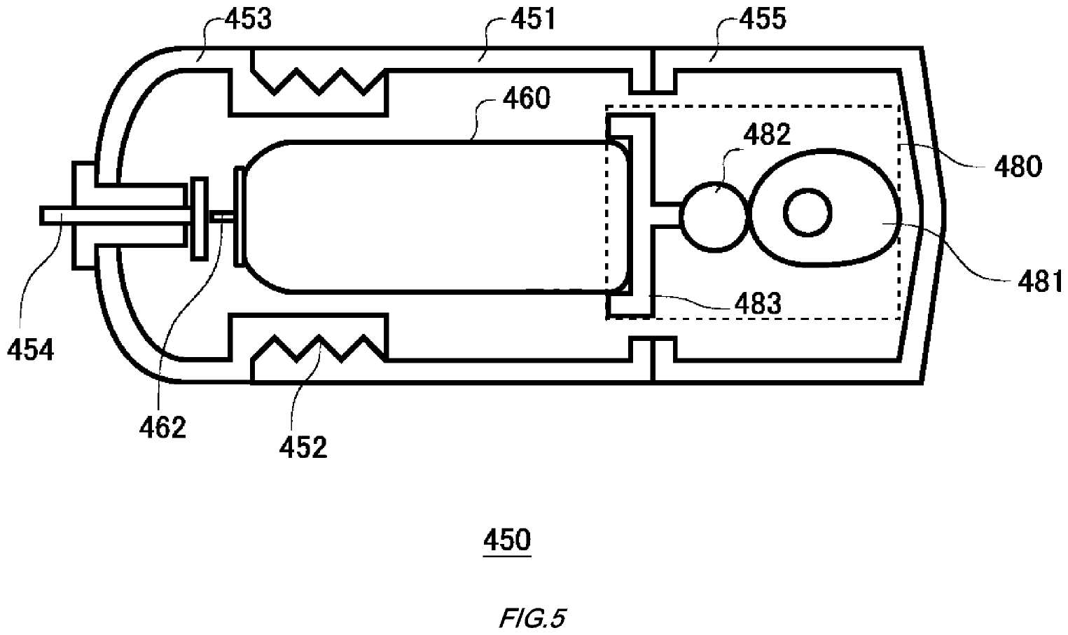

FIG. 5 is a diagram illustrating an example of the configuration of the discharge device 450. FIG. 5 illustrates a cross-sectional view of the discharge device 450. The discharge device 450 holds the container 460. The container 460 may be included as a component of the protection device 400.

The discharge device 450 of the present example includes a main body 451, a first end cover portion 453, and a second end cover portion 455. The discharge device 450 further includes a discharge drive unit 480 for controlling the discharge from the container 460.

The container 460 may be an aerosol container that discharges the content 465 filled therein by gas pressure. For example, the container 460 discharges the content 465 by the gas pressure of the liquefied gas or compressed gas filled therein. The container 460 of the present example is a metal aerosol can. The container 460 may be a plastic container having pressure resistance. The container 460 is mounted in a state of being accommodated in the discharge device 450. The container 460 is not limited to the aerosol container, and may be a resin tank.

The contents 465 may be selected according to a flight area of the unmanned aerial vehicle 100. In other words, the content 465 may be selected according to the intended use of the protection device 400. The content 465 may be a gas or a liquid. In addition, the content 465 discharged from the nozzle 414 may contain a liquid, may be a dry gas, or may be heated. The discharged content 465 may be water or may contain a chemical agent such as a repellent for a living body. The discharged content 465 may be air, N₂ or CO₂.

Alternatively, the content 465 may be selected according to characteristics of the sensor 50 mounted on the unmanned aerial vehicle 100. In a case where the ultrasonic sensor is mounted as the sensor 50, the content 465 may be a gas because sensitivity of the ultrasonic sensor decreases when the ultrasonic sensor is wetted with water.

Note that, as a propellant, a liquefied gas such as hydrocarbon (liquefied petroleum gas) (LPG), dimethyl ether (DME), or fluorinated hydrocarbon (HFO-1234ze), or a compressed gas such as carbon dioxide (CO₂), nitrogen (N₂), or nitrous oxide (N₂O) may be used.

The main body 451 has a cylindrical shape having a larger diameter than the container 460. The main body 451 of the present example is sandwiched between the first end cover portion 453 and the second end cover portion 455.

The first end cover portion 453 covers one end portion of the main body 451. The first end cover portion 453 of the present example covers the end portion on the injection side of the container 460. The first end cover portion 453 is detachably screwed and fixed to the main body 451 via a screw portion 452. The first end cover portion 453 of the present example has a dome-shaped cover main body. The diameter of the first end cover portion 453 is reduced so as to gradually decrease toward the edge in consideration of aerodynamic characteristics. The first end cover portion 453 has a conical or dome-shaped curved surface with a rounded edge. By having such a shape with favorable aerodynamic characteristics, the influence of the cross wind is reduced, and the flight can be stabilized.

The second end cover portion 455 covers the other end portion of the end portion covered by the first end cover portion 453 in the main body 451. The second end cover portion 455 of the present example covers the end portion of the container 460 on the side opposite to the injection side. The second end cover portion 455 is formed integrally with the main body 451. In addition, the second end cover portion 455 may be detachably provided with the main body 451.

The discharge drive unit 480 causes the content 465 to be discharged from the container 460 in response to a discharge signal received from the foreign object detection unit 412 described later, or an information acquisition unit 440 or an environment detection unit 442 described later. The discharge drive unit 480 is accommodated in the second end cover portion 455 located on the bottom side of the container 460. The second end cover portion 455 functions as a housing of the discharge drive unit 480. The discharge drive unit 480 includes a cam 481, a cam follower 482, and a movable plate 483. Since the discharge drive unit 480 is provided in the discharge device 450, it is not necessary to replace the discharge drive unit 480 when replacing the container 460.

The cam 481 is rotationally driven by a drive source. In one example, a motor is used as a drive source. The cam 481 has a structure in which the distance from the rotation center to the outer periphery is different. Note that, in the illustrated example, the shape of the cam 481 is exaggerated. The cam 481 is in contact with the cam follower 482 on the outer periphery.

The cam follower 482 is provided between the cam 481 and the movable plate 483. The cam follower 482 is connected to the cam 481 and the movable plate 483, and transmits the rotational motion of the cam 481 to the movable plate 483 as a linear motion.

The movable plate 483 is provided in contact with the bottom surface of the container 460, and controls opening and closing of the valve of the container 460. The movable plate 483 moves back and forth by the cam follower 482. For example, when the distance between the rotation center of the cam 481 and the contact region of the cam 481 with which the cam follower 482 abuts is short, the movable plate 483 retracts with respect to the container 460, and the valve of the container 460 is closed. On the other hand, when the distance between the rotation center of the cam 481 and the contact region of the cam 481 with which the cam follower 482 abuts is long, the movable plate 483 moves forward with respect to the container 460, and the valve of the container 460 opens.

Note that the discharge drive unit 480 is configured to convert rotational motion of the motor into linear motion by a cam mechanism, but is not limited to the cam mechanism. For example, the mechanism of the discharge drive unit 480 may be a mechanism that converts rotational motion of the motor into linear motion, such as a screw feed mechanism or a rack and pinion. In addition, as a drive source, a linear motor for linear drive, an electromagnetic solenoid, or the like may be provided instead of the rotary motor.

A stem 462 is provided on the container 460. When the stem 462 is pressed by an actuator 454, the content 465 is discharged from the container 460. The content 465 discharged from the container 460 is discharged from the nozzle 414 of the housing 410 via the extending portion 430.

Since the container 460 of the present example is an aerosol container, even when the container 460 becomes empty, it can be easily replaced only by mounting a new container 460. In addition, the content 465 is less likely to adhere to a human body, and the safety at the time of replacement is high.

### EXAMPLE 1

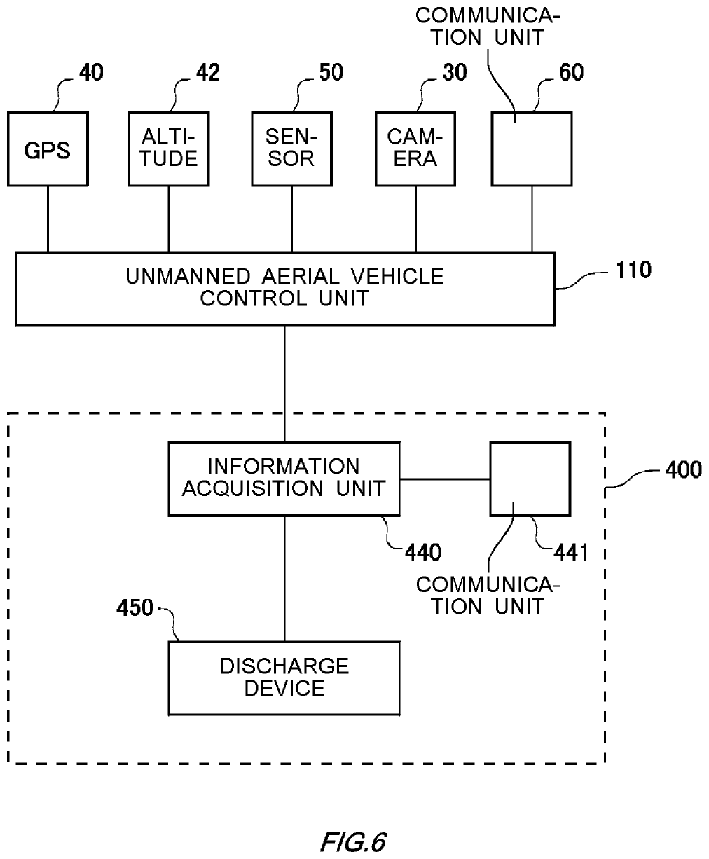

A protection device according to Example 1 will be described. FIG. 6 is a diagram illustrating an example of functional blocks of the protection device 400 according to Example 1. FIG. 6 illustrates an example of functional blocks of the unmanned aerial vehicle 100 in conjunction with functional blocks of the protection device 400.

An unmanned aerial vehicle control unit 110 is connected to the movable camera 30, the GPS information reception unit 40, an altitude information reception unit 42, the sensor 50, and a communication unit 60 in a wired or wireless manner. In one example, the unmanned aerial vehicle control unit 110, the movable camera 30, the GPS information reception unit 40, the altitude information reception unit 42, and the communication unit 60 are provided in the main body 10 of the unmanned aerial vehicle 100, and the sensor 50 is provided in the housing 410. The altitude information reception unit 42 acquires altitude information of the unmanned aerial vehicle 100 from an altimeter. The unmanned aerial vehicle control unit 110 acquires pilot information from the pilot device 200 via the communication unit 60.

The unmanned aerial vehicle control unit 110 acquires information from the movable camera 30, the GPS information reception unit 40, the altitude information reception unit 42, the sensor 50, and the communication unit 60 at a preset cycle, and controls the flight of the unmanned aerial vehicle 100 on the basis of the acquired information.

The protection device 400 of the present example includes the information acquisition unit 440, a communication unit 441, and the discharge device 450. The information acquisition unit 440 and the communication unit 441 may be respectively provided in the main body 10 of the unmanned aerial vehicle 100, and the unmanned aerial vehicle control unit 110 and the communication unit 60 may have these functions, respectively. The information acquisition unit 440 and the communication unit 441 are connected to each other in a wired or wireless manner. In addition, the information acquisition unit 440 is connected to the discharge device 450 in a wired or wireless manner. The information acquisition unit 440 is wirelessly connected to the pilot device 200 via the communication unit 441. In addition, the information acquisition unit 440 is connected to the unmanned aerial vehicle control unit 110 of the unmanned aerial vehicle 100 in a wired or wireless manner.

Alternatively, the information acquisition unit 440 and the communication unit 441 may be provided in the housing 410. In this case, the information acquisition unit 440 and the communication unit 441 are connected to each other in a wired or wireless manner. In addition, the information acquisition unit 440 is connected to the discharge device 450 in a wired or wireless manner. The information acquisition unit 440 is wirelessly connected to the pilot device 200 via the communication unit 441. In addition, the information acquisition unit 440 is connected to the unmanned aerial vehicle control unit 110 of the unmanned aerial vehicle 100 in a wired or wireless manner.

The information acquisition unit 440 acquires information from the outside, and transmits a discharge signal to the discharge device 450 based on the acquired information. In one example, the information acquisition unit 440 acquires information from the pilot device 200 via the communication unit 441. When the pilot device 200 transmits the discharge instruction of the pilot input by the discharge button 230 to the protection device 400, the information acquisition unit 440 transmits a discharge signal generated based on the acquired discharge instruction to the discharge device 450. The discharge drive unit 480 of the discharge device 450 opens and closes the valve of the container 460 based on the received discharge signal to discharge the content 465, and the content 465 is discharged from the nozzle 414 of the housing 410 via the extending portion 430.

Alternatively, the information acquisition unit 440 and the communication unit 441 may be provided in the discharge device 450. In this case, the information acquisition unit 440 and the communication unit 441 are connected to each other in a wired or wireless manner. The information acquisition unit 440 acquires information from the pilot device 200 via the communication unit 441. When the pilot device 200 transmits the discharge instruction of the pilot input by the discharge button 230 to the protection device 400, the information acquisition unit 440 outputs a discharge signal generated based on the acquired discharge instruction to the discharge drive unit 480. The discharge drive unit 480 opens and closes the valve of the container 460 based on the input discharge signal to discharge the content 465, and the content 465 is discharged from the nozzle 414 of the housing 410 via the extending portion 430.

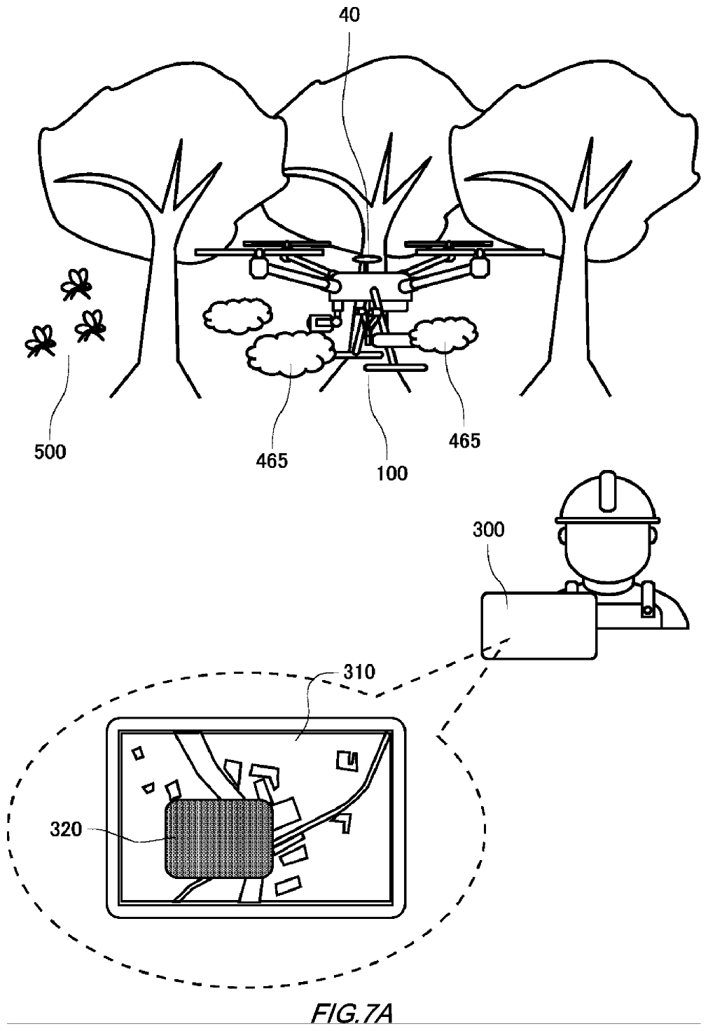

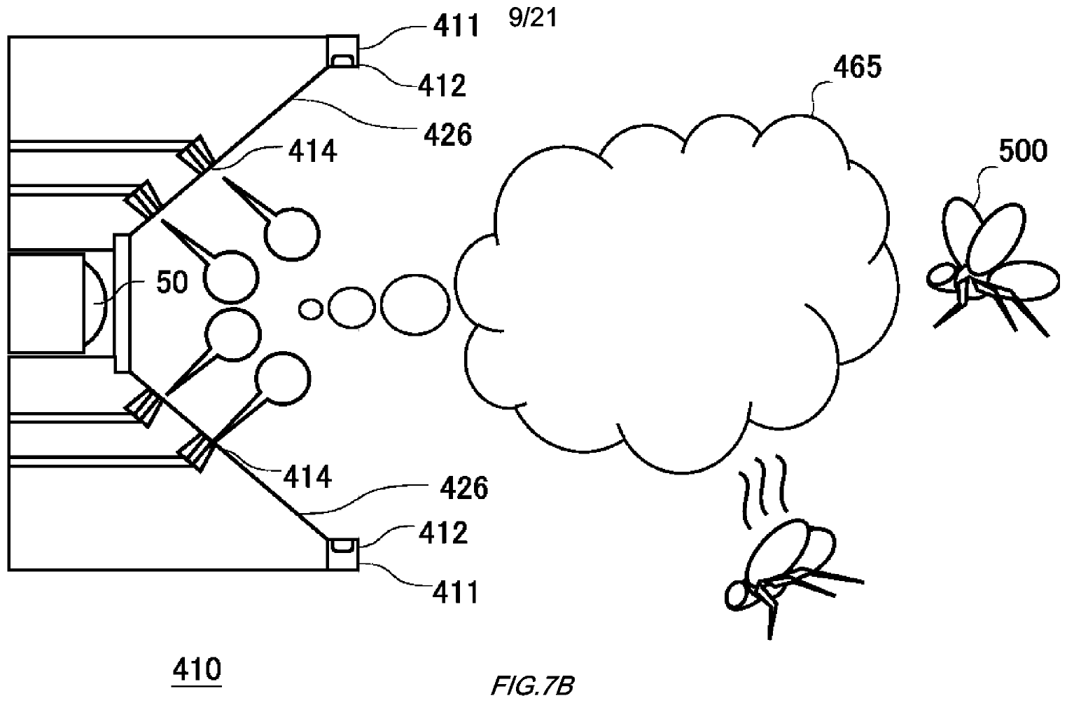

FIG. 7A is a diagram illustrating an example of an operation state of the protection device 400. Here, the operation of the protection device 400 will be described by taking a case where the unmanned aerial vehicle 100 enters the operation area 320 as an example.

The pilot of the unmanned aerial vehicle 100 inputs position information of the operation area 320 of the protection device 400 to the terminal device 300. The operation area 320 is an area set in advance such that the protection device 400 discharges the content 465 of the container 460 when the unmanned aerial vehicle 100 enters. In one example, the operation area 320 is an area such as a forest where the foreign objects 500 splatter. The terminal device 300 may indicate the operation area 320 on the map information displayed on the display unit 310.

The terminal device 300 transmits position information of the operation area 320 to the unmanned aerial vehicle control unit 110 in advance. The unmanned aerial vehicle control unit 110 stores the acquired position information of the operation area 320 in a memory or the like.

The terminal device 300 may transmit discharge control information such as a discharge time, an interval, and the number of times set by the pilot to the information acquisition unit 440 in advance. The information acquisition unit 440 stores the acquired discharge control information in a memory or the like.

During the flight of the unmanned aerial vehicle 100, the unmanned aerial vehicle control unit 110 compares the position information of the unmanned aerial vehicle 100 acquired from the GPS information reception unit 40 with the stored position information of the operation area 320. When the position information of the unmanned aerial vehicle 100 matches the position information of the operation area 320, the unmanned aerial vehicle control unit 110 transmits entry information indicating that the unmanned aerial vehicle 100 has entered the operation area 320 to the information acquisition unit 440 of the protection device 400. The information acquisition unit 440 transmits a discharge signal to the discharge device 450 based on the acquired entry information and the stored discharge control information.

In response to the discharge signal acquired by the discharge device 450, the content 465 of the container 460 is discharged from the nozzle 414. In one example, the discharged content 465 comprises a repellent for a living body. The discharged content 465 floats in the atmosphere in the vicinity of the inlet 411 of the housing 410 and obstructs the approach of the foreign object 500 to the sensor 50. As described above, the protection device 400 protects the sensor 50 by prophylactically discharging the content 465 of the container 460 from the nozzle 414 in the area where there are many foreign objects 500.

Alternatively, the protection device 400 may discharge the content 465 of the container 460 from the nozzle 414 in response to a discharge instruction of the pilot input from the pilot device 200. The pilot device 200 transmits the discharge instruction of the pilot input by the discharge button 230 to the protection device 400 via the antenna 210. The information acquisition unit 440 receives the discharge instruction via the communication unit 441, and transmits the discharge signal to the discharge device 450 based on the acquired discharge instruction.

As described above, the protection device 400 also protects the sensor 50 by discharging the content 465 of the container 460 from the nozzle 414 in response to an instruction from the pilot who has confirmed the situation of the flight area of the unmanned aerial vehicle 100 from the captured image of the movable camera 30 displayed on the display unit 310 of the terminal device 300.

FIG. 7B is a diagram illustrating an example of a cross section of the housing 410 in FIG. 7A.

The protection device 400 discharges the content 465 of the container 460 from the nozzle 414 based on the information acquired by the information acquisition unit 440. In one example, the discharged content 465 includes a nebulized biological repellent. The contents 465 discharged from the plurality of nozzles 414 are combined from the inside of the concave portion 420 of the housing 410 in the vicinity of the inlet 411 to form an air curtain, and block the approach of the foreign objects 500 to the sensor 50.

### EXAMPLE 2

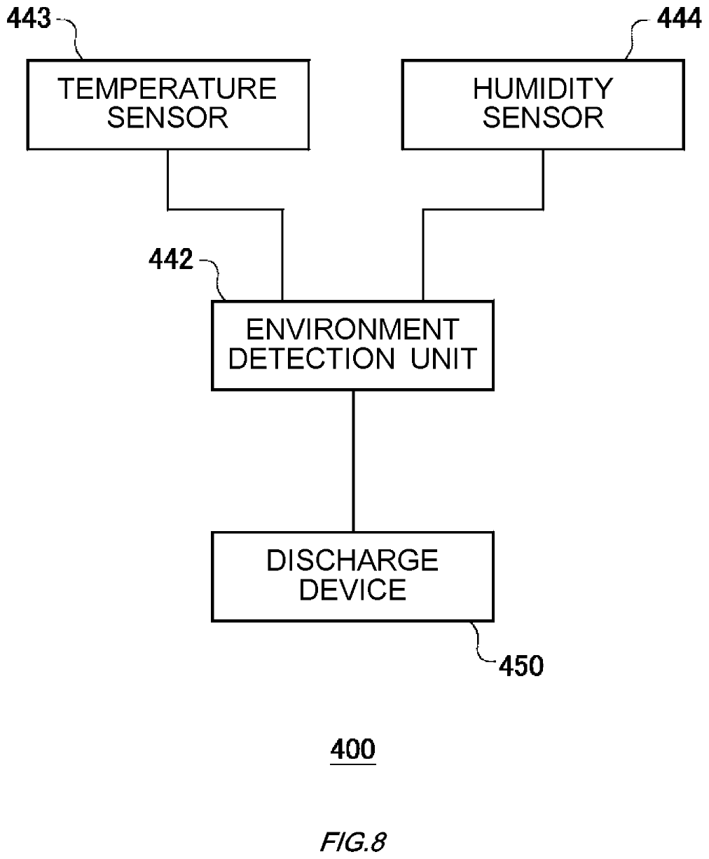

Next, a protection device according to Example 2 will be described. FIG. 8 is a diagram illustrating an example of functional blocks of the protection device 400 according to Example 2.

The protection device 400 of the present example includes the environment detection unit 442 that detects a change in environment, the temperature sensor 443 and the humidity sensor 444, and the discharge device 450. The temperature sensor 443 and the humidity sensor 444 are provided in the housing 410. The environment detection unit 442 may be provided in the main body 10 of the unmanned aerial vehicle 100, and the unmanned aerial vehicle control unit 110 may have the function thereof. Alternatively, the environment detection unit 442 may be provided in the housing 410. The environment detection unit 442 is connected to the temperature sensor 443 and the humidity sensor 444 in a wired or wireless manner. In addition, the environment detection unit 442 is connected to the discharge device 450 in a wired or wireless manner.

The temperature sensor 443 and the humidity sensor 444 measure the temperature and humidity in the housing 410, respectively, and transmit the temperature and humidity to the environment detection unit 442 at a preset cycle. The environment detection unit 442 detects a change in environment from the acquired temperature and humidity.

In one example, the environment detection unit 442 transmits the discharge signal to the discharge device 450 when detecting that the change amount of the temperature and the humidity exceeds a predefined threshold. The discharge drive unit 480 of the discharge device 450 opens and closes the valve of the container 460 based on the received discharge signal to discharge the content 465, and the content 465 is discharged from the nozzle 414 of the housing 410 via the extending portion 430.

Alternatively, the environment detection unit 442 may be provided in the discharge device 450. In this case, the environment detection unit 442 is connected to the temperature sensor 443 and the humidity sensor 444 in a wired or wireless manner. The environment detection unit 442 detects a change in environment from the acquired temperature and humidity. The environment detection unit 442 outputs a discharge signal to the discharge drive unit 480 when detecting that the change amount of the temperature and the humidity exceeds a predefined threshold. The discharge drive unit 480 opens and closes the valve of the container 460 based on the input discharge signal to discharge the content 465, and the content 465 is discharged from the nozzle 414 of the housing 410 via the extending portion 430.

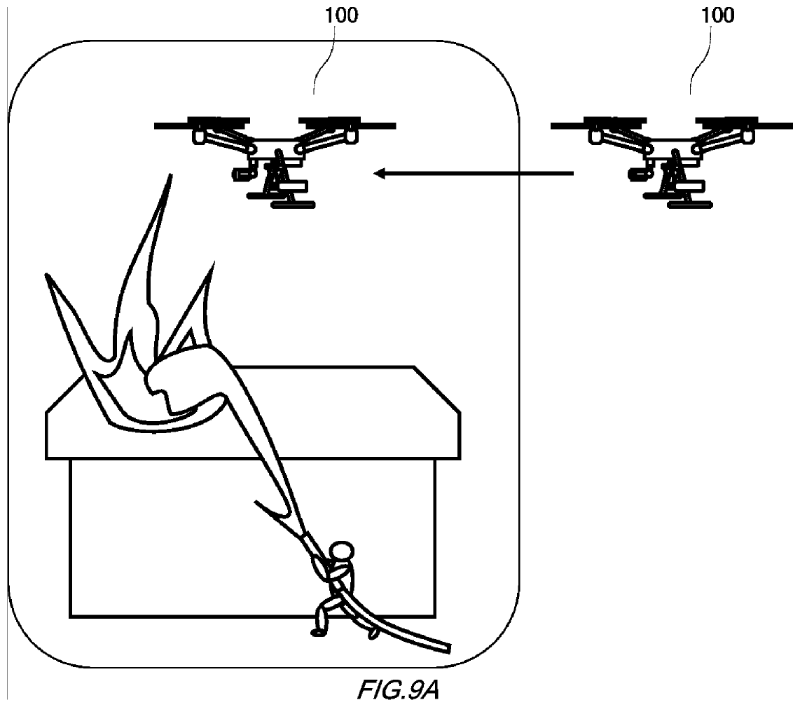

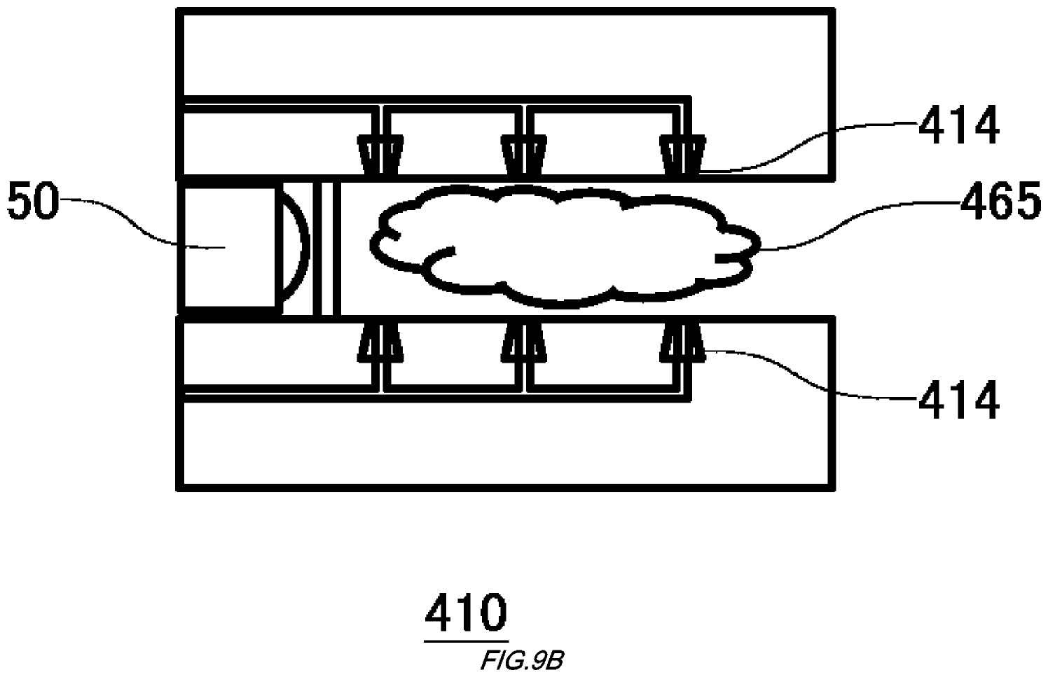

FIG. 9A is a diagram illustrating an example of an operation state of the protection device 400. Here, the operation of the protection device 400 will be described by taking a case where the unmanned aerial vehicle 100 enters a fire extinguishing activity site as an example.

Generally, the fire extinguishing activity site has a higher temperature and humidity than other areas. When the unmanned aerial vehicle 100 flies in the fire extinguishing activity site, the discharge device 450 accommodates the container 460 filled with a dry gas such as N₂ or CO₂ not containing moisture as the content 465.

When the unmanned aerial vehicle 100 enters the fire extinguishing activity site, the environment detection unit 442 detects that the temperature and the humidity have increased beyond predefined thresholds. The environment detection unit 442 transmits the generated discharge signal to the discharge device 450.

In response to the discharge signal acquired by the discharge device 450, the content 465 of the container 460 is discharged from the nozzle 414. The discharged content 465 reduces the moisture content in the atmosphere in the concave portion 420 of the housing 410.

FIG. 9B is a diagram illustrating an example of a cross section of the housing 410 in FIG. 9A.

The protection device 400 discharges the content 465 of the container 460 from the nozzle 414 based on the change detected by the environment detection unit 442. The contents 465 discharged from the plurality of nozzles 414 reduce the moisture content in the atmosphere in the concave portion 420 of the housing 410 and prevents dew condensation on the surface of the sensor 50.

Alternatively, when the unmanned aerial vehicle 100 flies in a cold district, the discharge device 450 may heat or keep temperature of the container 460 by a heating mechanism such that the discharged contents 465 become hot air. When detecting that the temperature has decreased to exceed a predefined threshold, the environment detection unit 442 transmits the generated discharge signal to the discharge device 450. In response to the discharge signal acquired by the discharge device 450, the content 465 of the container 460 is discharged from the nozzle 414. The discharged contents 465 increase the temperature in the concave portion 420 of the housing 410 to prevent freezing of the surface of the sensor 50.

### EXAMPLE 3

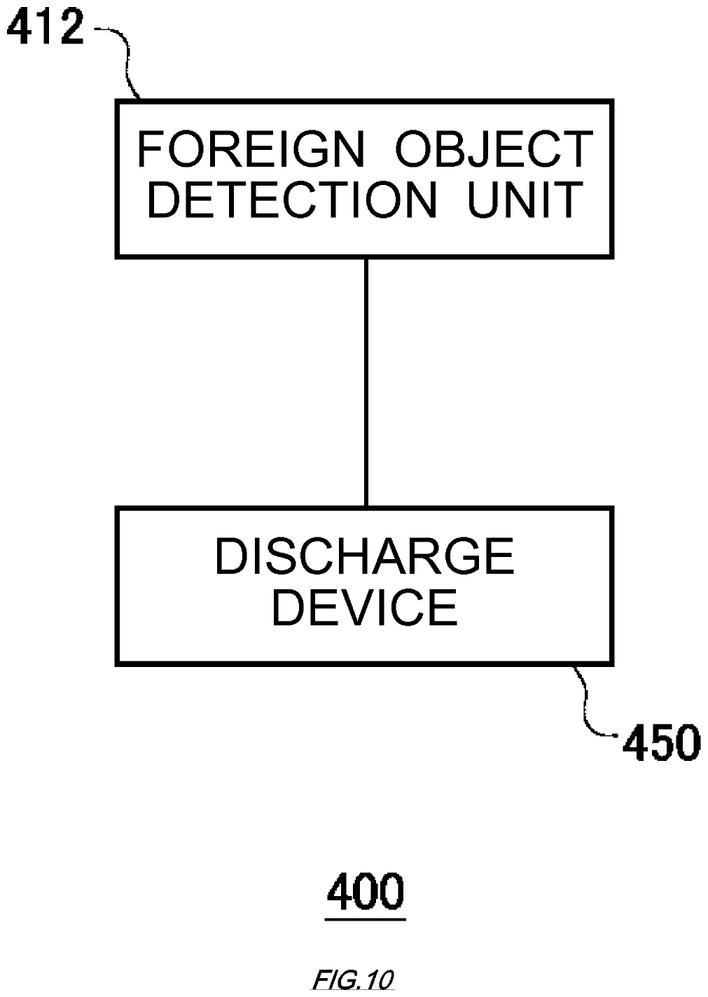

Next, a protection device according to Example 3 will be described. FIG. 10 is a diagram illustrating an example of functional blocks of the protection device 400 according to Example 3.

The protection device 400 of the present example includes the foreign object detection unit 412 that detects a foreign object and the discharge device 450. The foreign object detection unit 412 is provided in the housing 410. The foreign object detection unit 412 is connected to the discharge device 450 in a wired or wireless manner.

When detecting the foreign object 500, the foreign object detection unit 412 transmits the generated discharge signal to the discharge device 450. In response to the discharge signal acquired by the discharge device 450, the content 465 of the container 460 is discharged from the nozzle 414.

In this case, the content 465 may be a gas or may include a liquid. The protection device 400 may hit the detected foreign object 500 with the content 465 discharged from the nozzle 414, and remove the foreign object 500 by the impact. Alternatively, the content 465 may contain a repellent for a living body.

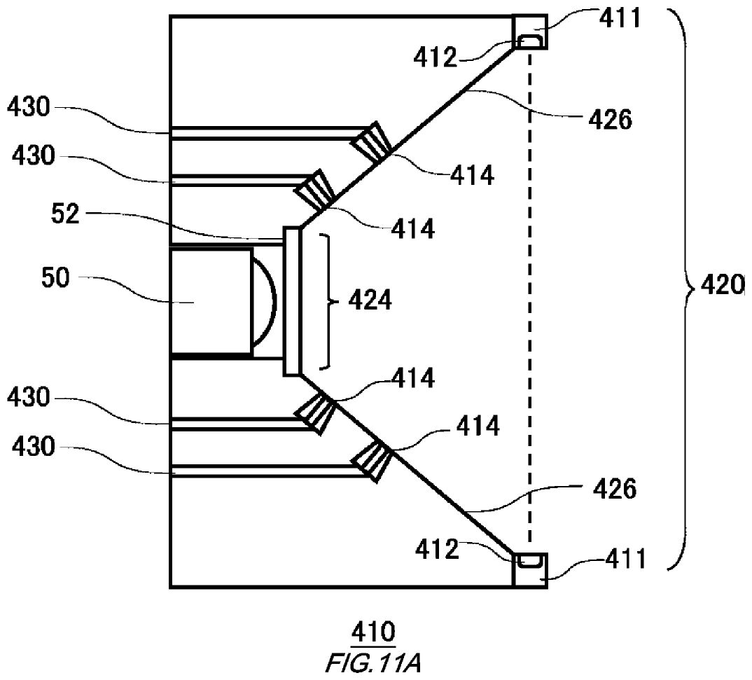

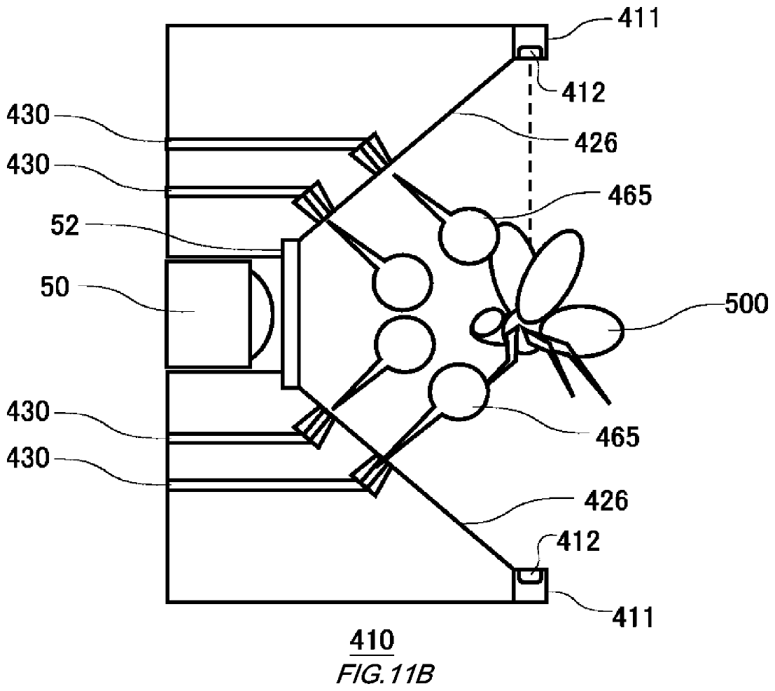

FIG. 11A is a cross-sectional view of the housing 410 illustrating an example of the foreign object detection unit 412. In FIG. 11, the foreign object detection unit 412 includes a pair of a light emitting portion and a light receiving portion provided in the vicinity of the inlet 411 of the housing 410. In one example, a camera and a sensor cover 52 as the sensor 50 are attached to the bottom portion 424 of the concave portion 420.

The light emitting portion of the foreign object detection unit 412 emits light toward the light receiving portion. When detecting the change in an amount of the received light of the light receiving portion, the foreign object detection unit 412 transmits the generated discharge signal to the discharge device 450. The discharge drive unit 480 of the discharge device 450 opens and closes the valve of the container 460 based on the received discharge signal to discharge the content 465, and the content 465 is discharged from the nozzle 414 of the housing 410 via the extending portion 430.

Note that, in a case where the unmanned aerial vehicle 100 flies in an area where the amount of ambient light is sufficiently strong, the foreign object detection unit 412 may have only the light receiving portion without having the light emitting portion.

FIG. 11B is a diagram illustrating an example in which the foreign object 500 approaches the foreign object detection unit 412 illustrated in FIG. 11A.

When the foreign object 500 passes through the path of the light from the light emitting portion toward the light receiving portion of the foreign object detection unit 412, the foreign object detection unit 412 detects a change in the amount of the received light of the light receiving portion and transmits the generated discharge signal to the discharge device 450.

In response to the discharge signal acquired by the discharge device 450, the content 465 of the container 460 is discharged from the nozzle 414. The discharged content 465 hits the foreign object 500 approaching the sensor 50 and removes the foreign object 500.

As described above, when the foreign object detection unit 412 detects the change in the amount of the received light of the light receiving portion, the protection device 400 determines that the foreign object 500 has approached the light receiving portion, discharges the content 465 of the container 460 from the nozzle 414, and protects the sensor 50 from the foreign object 500.

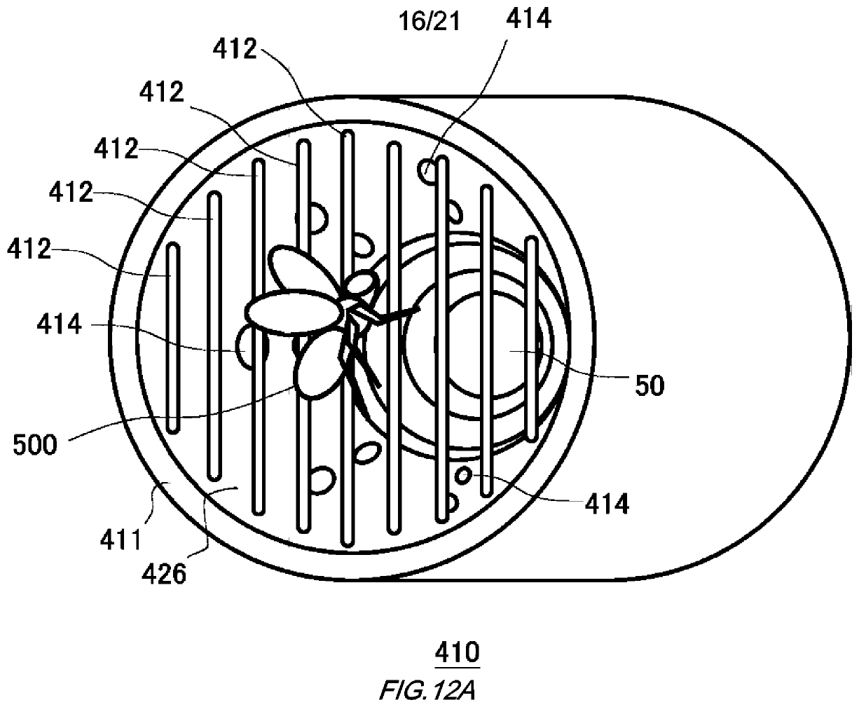

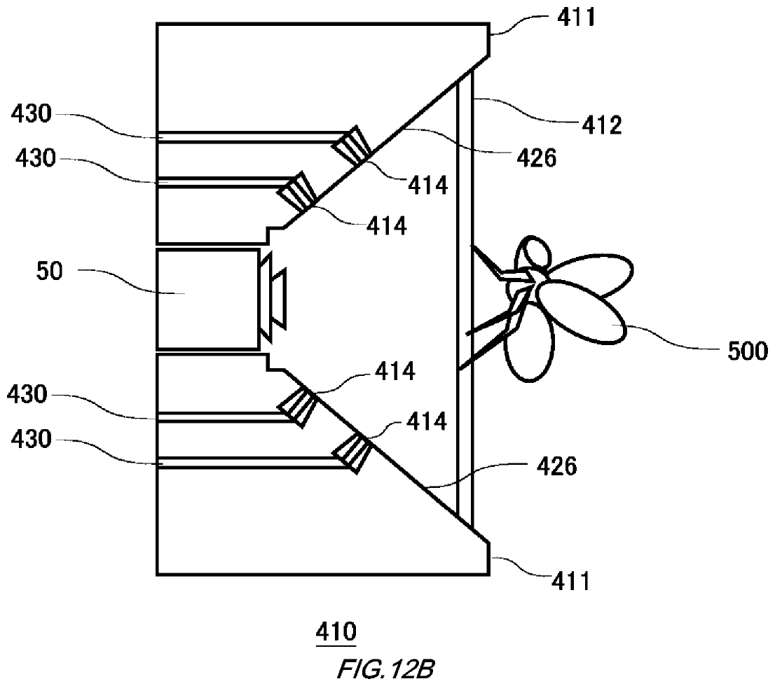

FIG. 12A is a perspective view of the housing 410 illustrating another example of the foreign object detection unit 412. In addition, FIG. 12B is a cross-sectional view of the housing 410 in FIG. 12A. The foreign object detection unit 412 includes an energization portion such as a wire provided in the vicinity of the inlet 411 of the housing 410. In one example, an ultrasonic sensor or the like is attached as the sensor 50 to the bottom portion 424 of the concave portion 420.

When detecting a change in electric resistance in the energization portion, the foreign object detection unit 412 transmits the generated discharge signal to the discharge device 450.

In response to the discharge signal acquired by the discharge device 450, the content 465 of the container 460 is discharged from the nozzle 414. The discharged content 465 hits the foreign object 500 approaching the sensor 50 and removes the foreign object 500.

As described above, when the foreign object detection unit 412 detects a change in electric resistance in the energization portion, the protection device 400 determines that the foreign object 500, which is a conductor, has come into contact with the energization portion, and discharges the content 465 of the container 460 from the nozzle 414 to protect the sensor 50 from the foreign object 500.

Note that the protection devices 400 according to Examples 1 to 3 may be combined. That is, the protection device 400 may include at least one of the information acquisition unit 440, the environment detection unit 442, and the foreign object detection unit 412.

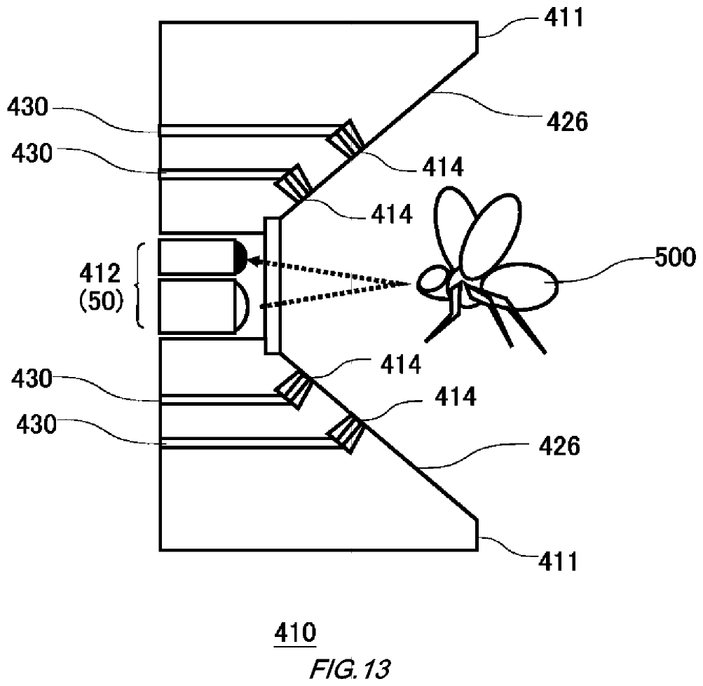

FIG. 13 is a cross-sectional view of the housing 410 illustrating another example of the foreign object detection unit 412. The foreign object detection unit 412 is attached to the bottom portion 424 of the concave portion 420 and operates as the sensor 50. In one example, the foreign object detection unit 412 is a distance measuring sensor such as an ultrasonic sensor or LiDAR. In one example, the foreign object detection unit 412 functions as the sensor 50 to monitor a distance to an obstacle around the unmanned aerial vehicle 100.

When the foreign object 500 is located in a path of an ultrasonic wave, a laser beam, or the like emitted by the foreign object detection unit 412, the foreign object detection unit 412 detects a steep change in the distance measurement value and transmits the generated discharge signal to the discharge device 450.

In response to the discharge signal acquired by the discharge device 450, the content 465 of the container 460 is discharged from the nozzle 414. The discharged content 465 hits the foreign object 500 approaching the sensor 50 and removes the foreign object 500.

As described above, when the foreign object detection unit 412 detects a steep change in the distance measurement value, the protection device 400 determines that the foreign object 500 has approached the sensor 50 (that is, the foreign object detection unit 412), and discharges the content 465 of the container 460 from the nozzle 414 to protect the sensor 50 from the foreign object 500.

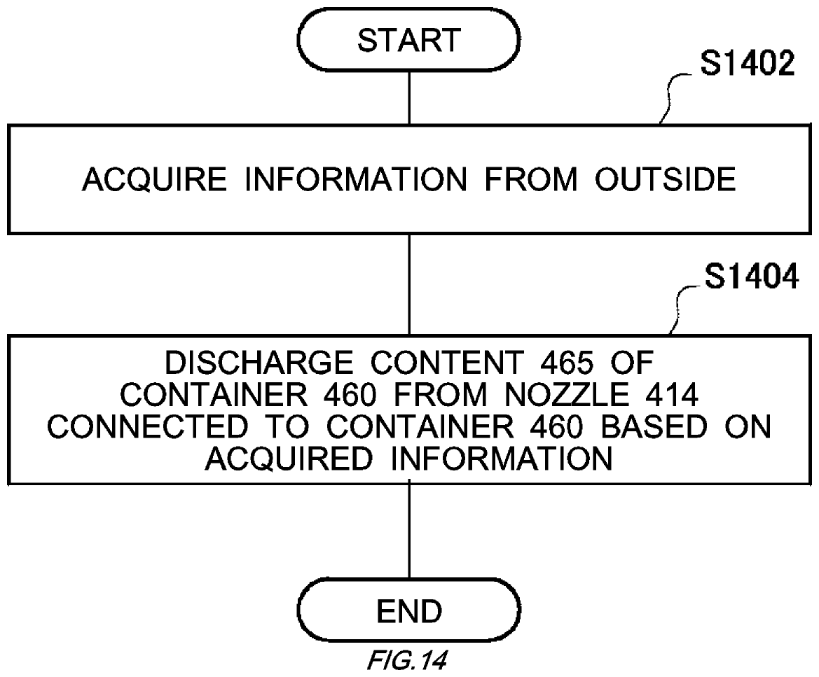

FIG. 14 is a flowchart illustrating an example of a protection method. The protection method of the present example may be applied to the protection device 400 described above.

In Step S1402, the protection device 400 acquires information from the outside.

In Step S1404, the protection device 400 discharges the content 465 of the container 460 from the nozzle 414 connected to the container 460 based on the acquired information.

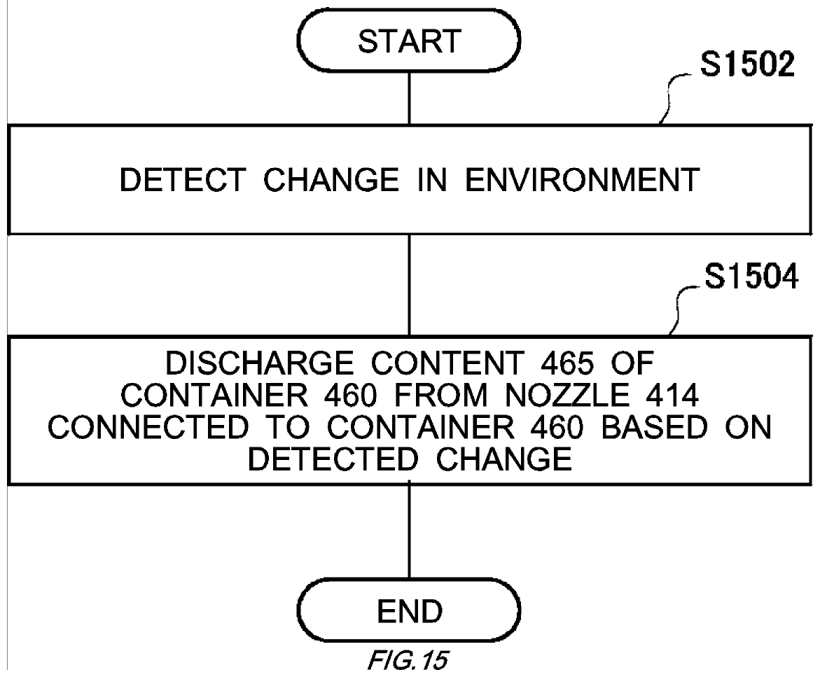

FIG. 15 is a flowchart illustrating another example of the protection method.

In Step S1502, the protection device 400 detects a change in environment.

In Step S1504, the protection device 400 discharges the content 465 from the nozzle 414 based on the detected change.

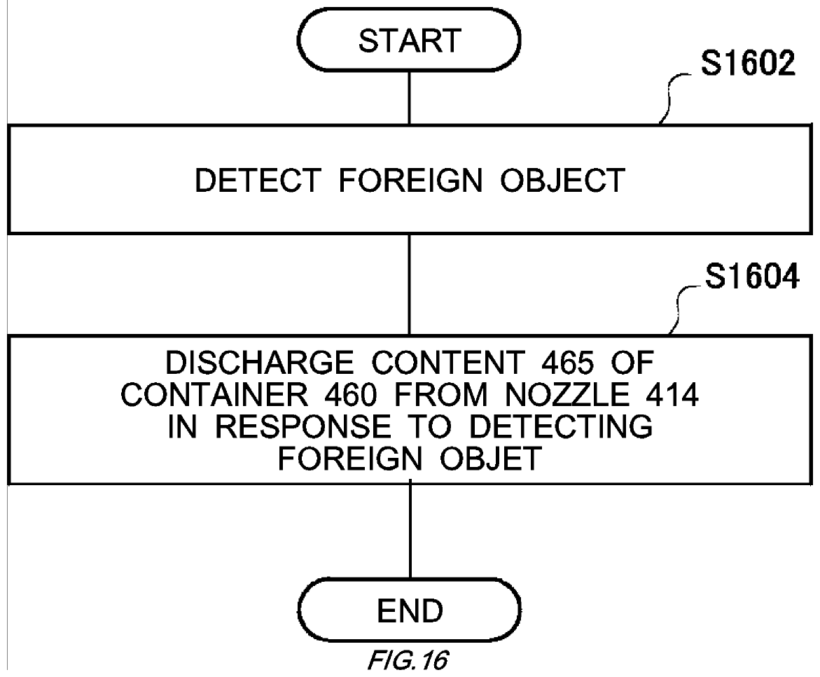

FIG. 16 is a flowchart illustrating another example of the protection method.

In Step S1602, the protection device 400 detects the foreign object 500.

In Step S1604, in response to detecting the foreign object 500, the protection device 400 discharges the content 465 from the nozzle 414.

As described above, the protection method of the present example protects the sensor 50 mounted on the unmanned aerial vehicle 100.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10: main body

15: leg portion

20: propulsion unit

21: rotation blade

22: rotation drive unit

24: arm portion

30: movable camera

32: coupling portion

40: GPS information reception unit

42: altitude information reception unit

50: sensor

52: sensor cover

60: communication unit

100: unmanned aerial vehicle

110: unmanned aerial vehicle control unit

200: pilot device

210: antenna

220: pilot stick

230: discharge button

300: terminal device

310: display unit

320: operation area

400: protection device

410: housing

411: inlet

412: foreign object detection unit

414: nozzle

420: concave portion

424: bottom portion

426: side surface

430: extending portion

440: information acquisition unit

441: communication unit

442: environment detection unit

443: temperature sensor

444: humidity sensor

450: discharge device

451: main body

452: screw portion

453: first end cover portion

454: actuator

455: second end cover portion

460: container

462: stem

465: content

480: discharge drive unit

481: cam

482: cam follower

483: movable plate

500: foreign object

1. A protection device for protecting a sensor mounted on an unmanned aerial vehicle, the protection device comprising:
a housing; and
a nozzle provided in the housing and connected to a container, wherein
the protection device is configured to protect the sensor by discharging a content of the container from the nozzle.

2. The protection device according to claim 1, further comprising:
an information acquisition unit configured to acquire information from an outside, wherein
the content is discharged from the nozzle based on the information acquired by the information acquisition unit.

3. The protection device according to claim 2, wherein
the information acquisition unit is configured to acquire operation information from an operator.

4. The protection device according to claim 2, wherein
the information acquisition unit is configured to acquire information from the unmanned aerial vehicle.

5. The protection device according to claim 1, further comprising:
an environment detection unit configured to detect a change in environment, wherein
the content is discharged from the nozzle based on the change detected by the environment detection unit.

6. The protection device according to claim 1, further comprising:
a foreign object detection unit configured to detect a foreign object, wherein
the content is discharged from the nozzle in response to the foreign object detection unit detecting the foreign object.

7. The protection device according to claim 6, wherein
the foreign object detection unit is provided closer to an inlet of the housing than the sensor, and the nozzle is provided between the sensor and the foreign object detection unit.

8. The protection device according to claim 6, wherein
the foreign object detection unit includes a light receiving portion, and is configured to detect a change in an amount of received light when the foreign object approaches the light receiving portion.

9. The protection device according to claim 6, wherein
the foreign object detection unit includes an energization portion, and is configured to detect a change in resistance when the foreign object comes into contact with the energization portion.

10. The protection device according to claim 6, wherein
the nozzle is provided between the sensor and an inlet of the housing, and
the foreign object detection unit is configured to operate as the sensor.

11. The protection device according to claim 1, wherein
the housing has a concave portion having a cylindrical or substantially tapered shape from an inlet of the housing toward a bottom portion, and
the sensor is attached to the bottom portion, and the nozzle is provided on a side surface of the concave portion.

12. The protection device according to claim 1, further comprising:
the container.

13. The protection device according to claim 1, wherein
the content is discharged from the nozzle in a direction different from a direction toward the sensor.

14. The protection device according to claim 1, wherein
the discharged content contains a liquid.

15. The protection device according to claim 1, wherein
the discharged content contains a repellent for a living body.

16. A protection method for protecting a sensor mounted on an unmanned aerial vehicle, the protection method comprising:
protecting the sensor by discharging a content of a container from a nozzle connected to the container.

17. The protection method according to claim 16, further comprising:
acquiring information from an outside; and
discharging the content from the nozzle based on the acquired information.

18. The protection method according to claim 16, further comprising:
detecting a change in environment; and
discharging the content from the nozzle based on the detected change.

19. The protection method according to claim 16, further comprising:
detecting a foreign object; and
discharging the content from the nozzle in response to detecting the foreign object.

20. An unmanned aerial vehicle comprising a [[the]] protection device for protecting a sensor to be mounted, wherein
the protection device includes:
a housing; and
a nozzle provided in the housing and connected to a container, and
the protection device is configured to protect the sensor by discharging a content of the container from the nozzle.
